(19) United States
(12) Patent Application Publication
(10) Pub. No.: US 2015/0339619 A1
(43) Pub. Date: Nov. 26, 2015

(54) AUTOMATICALLY UPDATING WORK SCHEDULES

(71) Applicant: MCKINSEY & COMPANY, INC., Wilmington, DE (US)

(72) Inventors: Charles Dumont, Montreal (CA); Rocco Colasante, Chieti (IT); Alvise Favara, Satigny (CH); Emanuele Riva, Erba (IT); Filippo Rossi, Paris (FR); Paul Michael Sullivan, Highlands Ranch, CO (US)

(73) Assignee: MCKINSEY & COMPANY, INC., Wilmington, DE (US)

(21) Appl. No.: 14/286,348

(22) Filed: May 23, 2014

(51) Int. Cl. G06Q 10/06

(52) U.S. Cl. CPC G06Q 10/063116

(57) ABSTRACT

A computer-implemented method for automatically updating work schedules includes distributing a first plurality of work schedules to a work crew. The method further includes receiving productivity updates from the work crew, the productivity updates indicative of an actual amount of work accomplished by the work crew in the first time period, and, based on one or more differences between the actual amount of work and the estimated amount of work, updating the one or more initial estimates of productivity. Still further, the method includes causing a schedule generator to generate a second plurality of work schedules based on the one or more updated estimates of productivity, and distributing the second plurality of work schedules to the work crew.

### TECHNICAL FIELD

The present disclosure generally relates to managing one or more work crews and, more particularly, to a method for gathering productivity information and updating work schedules for a work crew.

### BACKGROUND

Work projects, such as construction projects, typically involve many different and possibly dependent work activities, employment of multiple work crews, and variable work conditions and/or work crew productivities. For example, a construction project may include a plurality of work crews, each responsible for corresponding tasks, such as pouring concrete, installing steel supports, installing electric systems, etc., where each task can be dependent on the completion of one or more of other tasks. As such, the planning, management, and control of such projects is particularly challenging, and many software applications and web-based collaboration tools have been developed in an attempt to streamline project control and planning.

Some project control applications utilize project plans, work schedules, and models created at the beginning of a project (i.e., before a project actually begins). Such initial planning of a project often results in unfeasible/unrealistic deadlines, multiple schedules with unresolved conflicts, lack of alignment among stakeholders leading to poor collaboration, lack of detailed plans to properly steer project activities, and lack of a compensation for unforeseen contingencies.

Some other project control applications attempt to implement a recurring planning of projects with portions of project planning completed at various stages of project. However, even these project control applications suffer due to relatively static project plans (lacking detailed and regular updates), plans that are not deployed at an individual worker level, and plans that are not forward-looking to potential project issues. Frequently, current project control applications generate project targets that are not effectively communicated to work crews, gather data that is not sufficiently up-to-date or transparent so as to support executive decisions, and forego beneficial actions that may improve project outcomes (e.g., project duration or cost).

### SUMMARY

In one embodiment, a computer-implemented method for automatically updating work schedules comprises distributing, via a computer network, a first plurality of work schedules to a work crew. The first plurality of work schedules are based on one or more initial estimates of productivity corresponding to the work crew, and the first plurality of work schedules indicate a first estimated amount of work to be accomplished by the work crew on a project in a first time period. The method further comprises receiving, via the computer network, productivity updates from the work crew, the productivity updates indicative of an actual amount of work accomplished by the work crew in the first time period, and, based on one or more differences between the actual amount of work and the estimated amount of work, updating, with one or more processors, the one or more initial estimates of productivity to generate one or more updated estimates of productivity corresponding to the work crew. Still further, the method includes causing, with the one or more processors, a schedule generator to generate a second plurality of work schedules based on the one or more updated estimates of productivity. The second plurality of work schedules indicate a second estimated amount of work to be accomplished by the work crew on the project in a second time period different from the first time period, and the second estimated amount of work is different from the first estimated amount of work. The method further comprises distributing, via the computer network, the second plurality of work schedules to the work crew.

In another embodiment, a computer device for automatically updating work schedules comprises one or more processors and one or more non-transitory memories coupled to the one or more processors. The one or more memories include computer executable instructions stored therein that, when executed by the one or more processors, cause the one or more processors to distribute, via a computer network, a first plurality of work schedules to a work crew. The first plurality of work schedules is based on one or more initial estimates of productivity corresponding to the work crew, and the first plurality of work schedules indicate a first estimated amount of work to be accomplished by the work crew on a project in a first time period. The computer executable instruction further cause the one or more processors to receive, via the computer network, productivity updates from the work crew, the productivity updates indicative of an actual amount of work accomplished by the work crew in the first time period, based on one or more differences between the actual amount of work and the estimated amount of work, update the one or more initial estimates of productivity to generate one or more updated estimates of productivity corresponding to the work crew, and cause a schedule generator to generate a second plurality of work schedules based on the one or more updated estimates of productivity. The second plurality of work schedules indicate a second estimated amount of work to be accomplished by the work crew on the project in a second time period different from the first time period, and the second estimated amount of work is different from the first estimated amount of work. Still further, the computer executable instruction cause the one or more processors to distribute, via the computer network, the second plurality of work schedules to the work crew.

In yet another embodiment, A system for managing a project based on automatically updated productivities comprises a scheduler engine configured to generate work schedules based on productivity estimates corresponding to a work crew and a productivity update engine coupled to the scheduler engine. The productivity update engine is configured to distribute, via a computer network, a first plurality of work schedules to a work crew. The first plurality of work schedules is generated by the scheduler engine based on one or more initial estimates of productivity corresponding to the work crew, and the first plurality of work schedules indicates a first estimated amount of work to be accomplished by the work crew on a project in a first time period. The productivity update engine is further configured to receive, via the computer network, productivity updates from the work crew, the productivity updates indicative of an actual amount of work accomplished by the work crew in the first time period, and based on one or more differences between the actual amount of work and the estimated amount of work, update, with the one or more processors, the one or more initial estimates of productivity to generate one or more updated estimates of productivity corresponding to the work crew. Still further, the productivity update engine is configured to cause, with the one or more processors, the scheduler engine to generate a second plurality of work schedules based on the one or more updated estimates of productivity. The second plurality of work schedules indicates a second estimated amount of work to be accomplished by the work crew on the project in a second time period different from the first time period, and the second estimated amount of work is different from the first estimated amount of work. The productivity update engine is also configured to distribute, via the computer network, the second plurality of work schedules to the work crew.

### BRIEF DESCRIPTION OF THE DRAWINGS

FIG. 1 illustrates an example system for managing a work crew via automatically updated work schedules and productivity estimates.

FIG. 2 is a flow diagram of an example method for automatically updating work schedules which may be implemented in the system illustrated in FIG. 1.

FIGS. 3A and 3B are screenshots of example work schedules displayed on work crew devices, such as the work crew devices illustrated in FIG. 1.

FIGS. 4A-4E are screenshots of example update interfaces allowing members of a work crew to communicate actual amounts of work accomplished while working on work schedules, such as the work schedules illustrated in FIGS. 3A and 3B.

FIG. 5 is a screenshot of an example report generated from up-to-date project data, such as data stored in the database illustrated in FIG. 1.

FIG. 6 is a screenshot of an example mobile alert generated based on up-to-date project data, such as data stored in the database illustrated in FIG. 1.

FIGS. 7A and 7B are screenshots of other example reports generated from up-to-date project data, such as data stored in the database illustrated in FIG. 1.

### DETAILED DESCRIPTION

Although the following text sets forth a detailed description of numerous different embodiments, it should be understood that the legal scope of the description is defined by the words of the claims set forth at the end of this disclosure. The detailed description is to be construed as exemplary only and does not describe every possible embodiment since describing every possible embodiment would be impractical, if not impossible. Numerous alternative embodiments could be implemented, using either current technology or technology developed after the filing date of this patent, which would still fall within the scope of the claims.

It should also be understood that, unless a term is expressly defined in this patent using the sentence “As used herein, the term ‘______’ is hereby defined to mean. . . . ” or a similar sentence, there is no intent to limit the meaning of that term, either expressly or by implication, beyond its plain or ordinary meaning, and such terms should not be interpreted to be limited in scope based on any statement made in any section of this patent (other than the language of the claims). To the extent that any term recited in the claims at the end of this patent is referred to in this patent in a manner consistent with a single meaning, that is done for sake of clarity only so as to not confuse the reader, and it is not intended that such claim term by limited, by implication or otherwise, to that single meaning. Finally, unless a claim element is defined by reciting the word “means” and a function without the recital of any structure, it is not intended that the scope of any claim element be interpreted based on the application of 35 U.S.C. §112, sixth paragraph.

The term “project” or “work project” may refer to any of a number of managed processes involving the planning and execution of a plurality of activities. A project may be a construction or building project (e.g, construction or assembly of infrastructure), product assembly or manufacturing project, product design and testing project, demolition or salvage project, software engineering project, natural resource management project, disaster cleanup project, chemical production or application project, transportation or logistics project, agricultural project, etc.

Additionally, as used herein, the term “work crew” may refer to any group of persons responsible for completing certain tasks associated with a project. A work crew may be a construction crew, road crew, engineering team, forestry crew, group of equipment operators, group of plant employees, etc.

### System Overview

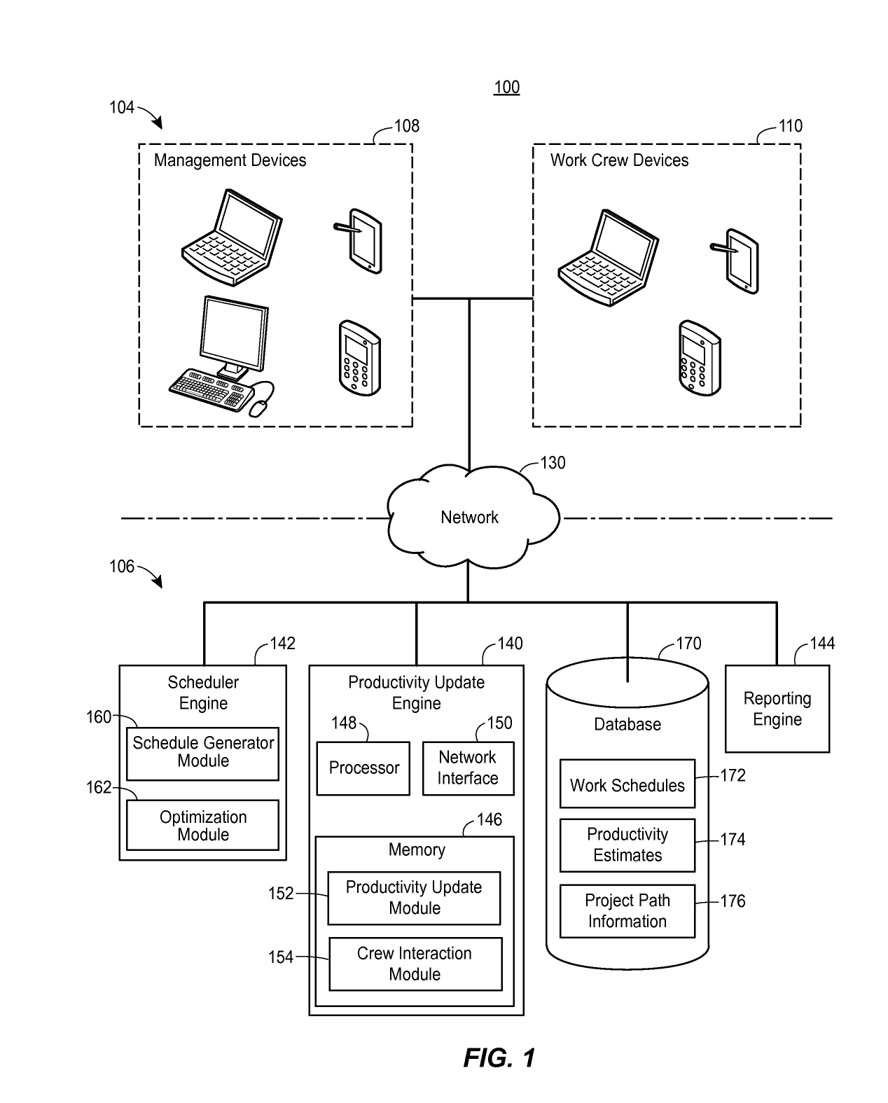

FIG. 1 illustrates an example system 100 for managing a work crew via automatically updated productivities and work schedules. The high-level architecture includes both hardware and software applications, as well as various data communications channels for communicating data between the various hardware and software components.

The system 100 may be roughly divided into one or more front-end components 104 and one or more back-end components 106. The front-end components 104 may include a plurality of management devices 108 and a plurality of work crew devices 110. Business, executive, or other management personal, associated with a work project, may operate the management devices 108, which may include laptop computers, desktop computers, tablet computers, smartphones, personal digital assistants (PDAs), etc. Members of a work crew (e.g., working onsite at a work project) may operate the work crew devices 110 which may include any suitable mobile computing devices, in an implementation, such as phones, smartphones, tablet computers, laptop computers, etc. However, it is understood that the management devices 108 and the work crew devices 110 may include any suitable combination of computing devices, whether stationary or mobile.

Although not shown in FIG. 1, the management devices 108 and the work crew devices 110 may include any number of computer processors, user interfaces (including a touchscreen, keyboard, etc.), and memories (e.g., volatile memory, non-volatile memory, or a combination thereof). The management devices 108 and/or the work crew devices 110 may execute various applications, stored in local memories, to facilitate interactions and communications with the back end components 106. For example, the management devices 108 and the work crew device 110 may execute a web browser application, such as Google Chrome™ browser or Apple Safari® Application Program, or an “installed” application specially configured for interactions with the back end components 106.

The front-end components 104 may communicate with the back-end components 106 via the network 130. The network 130 may be a proprietary network, a secure public internet, a virtual private network or some other type of network, such as dedicated access lines, plain ordinary telephone lines, satellite links, combinations of these, etc. Where the network 130 comprises the Internet, data communications may take place over the network 130 via an Internet communication protocol.

The back-end components 106 may include a productivity update engine 140, a scheduler engine 142, and a reporting engine 144. The engines 140, 142, and 144 may include one or more remote computing devices, such as servers, configured to execute applications, process communications, manipulate data, store and retrieve data, send and receive data from the front end components 104, etc. Although FIG. 1 illustrates each of the engines 140, 142, and 144 as a single unit, each of the engines 140, 142, and 144 may include any suitable number of servers, or other computing devices, with any number of processors. For example, some or all of the functionality of the engines 140, 142, and 144 may be distributed among a plurality of servers in an arrangement known as “cloud computing,” in an implementation. This configuration may provide several advantages, such as, for example, enabling near real-time uploads and downloads of information as well as periodic uploads and downloads of information. Likewise, some or all of the functionality of the engines 140, 142, and 144 may be combined into one or more software applications executed by a single server.

In particular, the productivity update engine 140 may include a memory 146, one or more processors 148 (may be called a microcontroller or a microprocessor), and a network interface 150, all of which may be interconnected via an address/data bus (not shown). The memory 146 may be configured to store computer-readable instructions that when executed by the one or more processors 148 cause the productivity update engine 148 to implement a productivity update module 152 and a crew interaction module 154. The memory 146 may include volatile memory, non-volatile memory, or a combination thereof. For example, the memory 146 may be implemented as random access memory (RAM), read only memory (ROM), or any other types of semiconductor memory, magnetically readable memory, and/or optically readable memory.

The scheduler engine 142 and the reporting engine 144 may include substantially similar components (processors, memories, etc.) as those components of the productivity update engine 140. The engines 142 and 144 may also execute, with one or more processors, computer-readable instructions so as to implement various applications or modules, such as a schedule generator module 160 and an optimization module 162, for example.

The productivity update engine 140, the scheduler engine 142, and the reporting engine 144 may be communicatively and/or operatively coupled to one or more databases, such as the database 170. Each of the engines 140, 142, and 144 may store data on, retrieve data from, and/or manipulate data entries in the database 170, in an implementation. In particular, the database 170 may include, by way of example, data entries (e.g., records) indicative of: (i) a plurality of work schedules 172 corresponding to one or more work crews associated with one or more projects; (ii) a plurality of productivity estimates 174 corresponding to one or more work crews; and (iii) project path information 176 related to overall project metrics or project management (times to completion, critical activities, etc.). The database 170 may include structured (e.g., SQL) and/or unstructured (NoSQL) elements, entries, or records, and the engines 140, 142, and 144 may query or store data entries in the database 170 via any suitable database language, framework, or protocol, such as IBM DB2® Database Server, Oracle® Database, Apache™ Hadoop® Software Framework, MongoDB® Open-Source Document Database, etc.

In an implementation, the scheduler engine 142 may generate one or more work schedules for a work crew based on estimates of productivity corresponding to the work crew. To this end, the scheduler engine 142 may retrieve estimates from the plurality of productivity estimates 174 and/or directly from the productivity update engine 140. Alternatively, the scheduler engine 142 may determine initial estimates of productivity based on a stored productivity model or user input via a user interface (not shown) operatively coupled to the scheduler engine 142. By way of example and without limitation, the productivity estimates may include values such as quantity/man-hour (e.g., ten windows installed per man-hour), physical measurement/man-hour (e.g., five meters of pipeline installed per man-hour), quantity/time, physical measurement/time, average rate of production, quantities/man, etc. Generally, the productivity estimates may include any suitable representation of the productivity of a work crew as related to a work project.

The scheduler engine 142 may, based on estimates of productivity, execute the optimization module 162 to optimize one or more outcomes of a project, such as duration, quantity of units produced, materials installed, etc. In some implementations, the optimization module 162 may include a critical path algorithm for scheduling work crew activities and determining activity dependencies. For example, the optimization module 162 may calculate a “longest path” of one or more activities (e.g., pouring a foundation, framing a structure, etc.) to an end point and a time at which each activity must begin/end. The optimization module 162 may also optimize one or more objective functions. That is, the optimization module 162 may attempt to calculate a best possible value of some objective function (e.g., representing length of a project, duration of an activity or task, or financial cost of a project) given certain constraints (e.g., number of workers). In some implementations, the optimization module 162 may output one or more models of a project, optimized values, etc. to the schedule generator module 160, and/or to the database 170.

The scheduler engine 142 may execute the schedule generator module 160, according to productivity estimates and/or optimized output of the optimization module 162, to generate one or more work schedules for a work crew. The work schedules for the work crew may include, by way of example, an estimated quantity of units to be produced by the work crew, an estimated number of hours to be worked by the work crew, or one or more physical measurements of new additions to structures to be completed by the work crew in a certain time period. It is clear, however, that the work schedules may include any suitable type of time-based plans for instructing the work of a work crew in a certain time period. The work schedules may be organized by shift, hour, day, week, month, etc. and may be further organized by work tasks, such as pouring concrete, laying pipe, running electrical wiring, etc.

The work crew may be associated with one particular project, but, in general, the work crew may be assigned to any number of projects. For example, a company managing a certain work crew according to a utilization of the system 100 may simultaneously assign a work crew to multiple projects (e.g., building multiple commercial buildings). As such, the work schedules, generated by the scheduler engine 142, may indicate how the work of such a work crew is to be spread among the various projects in a given day, week, month, etc. along with indications of how the work of the work crew is to be spread among various task associated with each project.

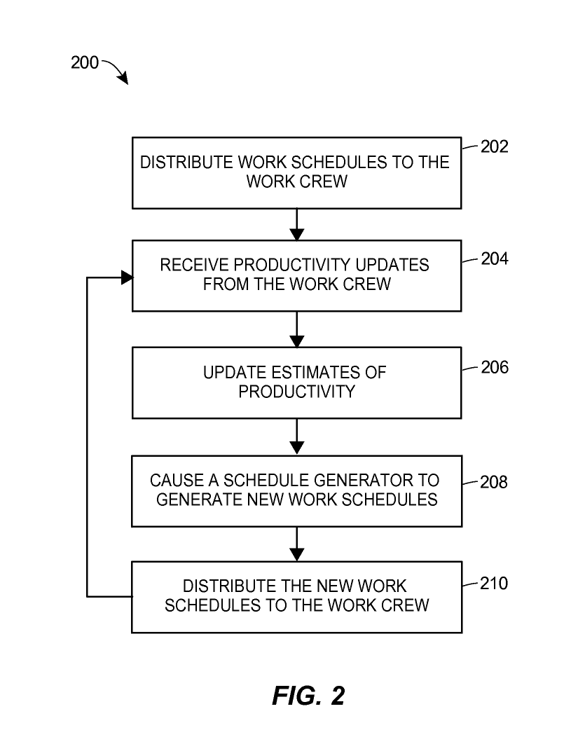

The scheduler engine 142 may communicate work schedules to the productivity update engine 140, and the productivity update engine 140 may execute the crew interaction module 154 to distribute the work schedules to the plurality of work crew devices 110. The plurality of work crew devices 110 (e.g., each corresponding to a respective member of the work crew) may then display representations of the work schedules on respective user interfaces, as discussed further with respect to FIG. 2.

The productivity update engine 140 may also receive productivity updates from the work crew device 110. For example, after a shift, day, week, month, etc. of work on a project, members of work crew (who previously received work schedules) may input actual amounts of work accomplished (during the shift, day, week, etc.) into the corresponding ones of the work crew devices 110. The work crew devices 110 may communicate this input and possibly other crew-device interactions to the productivity update engine 140. In this way, the work crew may easily receive work schedules for one or more projects and communicate what amounts of work are actually being completed on those one or more projects.

The productivity update engine 140 may, based on productivity updates from one or more work crews, update productivity estimates corresponding to the one or more work crews. For example, the productivity update engine 140 may execute the productivity update module 152 to update one or more productivity estimates (e.g., stored in the database 170). The updates to the productivity estimates may include operations such as replacing estimate values with new productivity estimate values, increasing or decreasing productivity estimate values, adding or deleting productivity estimate values, applying transformations (e.g., convolutions with mathematical functions) to one or more productivity estimates, etc.

Productivity estimates and updates to those productivity estimates, e.g., generated by the productivity update engine 140, may include, by way of example, one or more numerical values and/or labels expressible in the form of a “productivity matrix.” Such a matrix representation of productivity estimates may be manipulated or utilized by algorithms or methods, in some implementations. For example, the optimization module 162 may include an optimization algorithm in matrix form, where the algorithm utilizes a productivity matrix to accurately optimize one or more project outcomes, such as project duration or cost.

### Automatically Updating Work Schedules

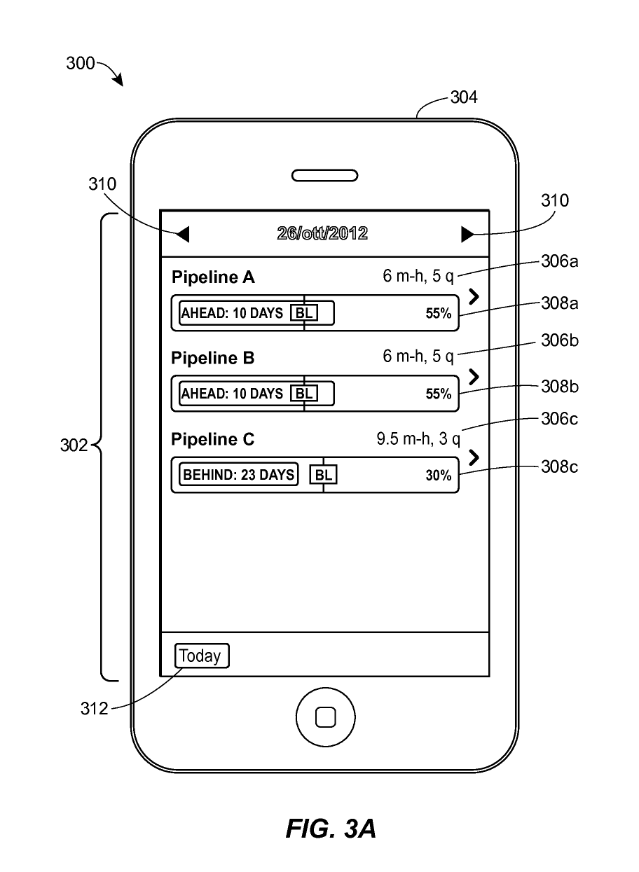

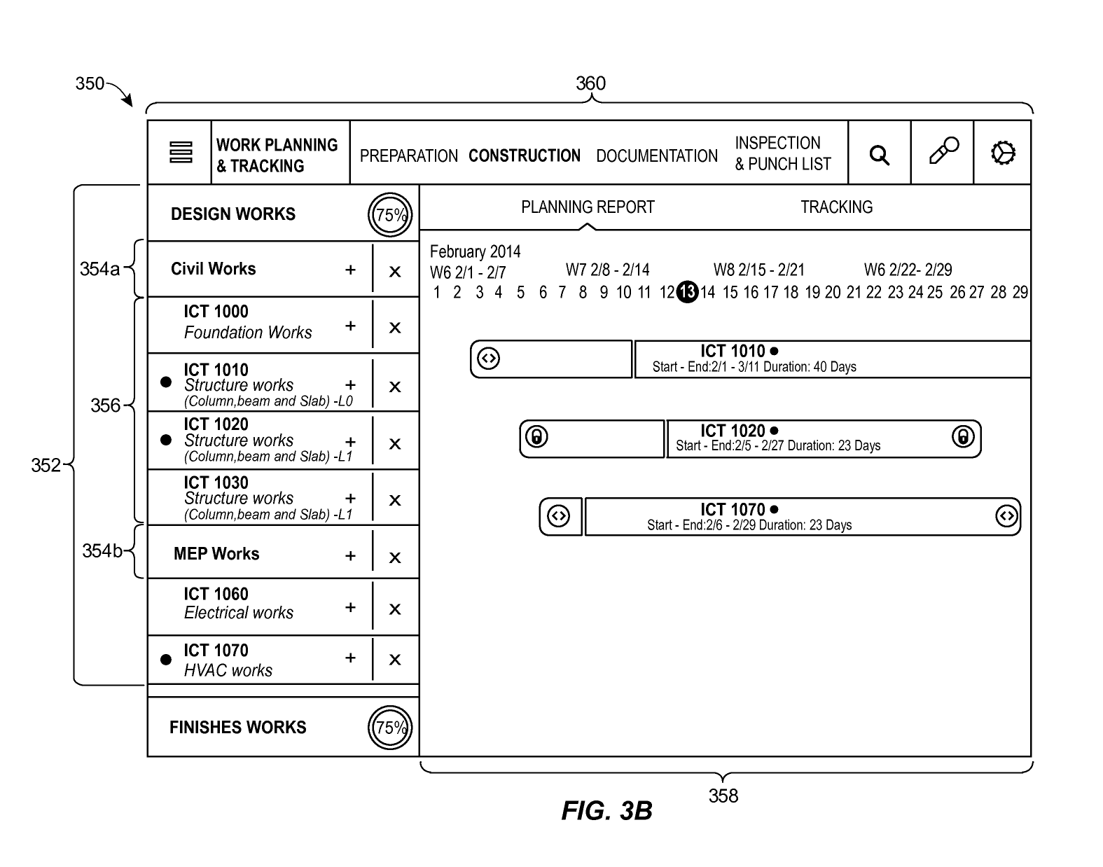

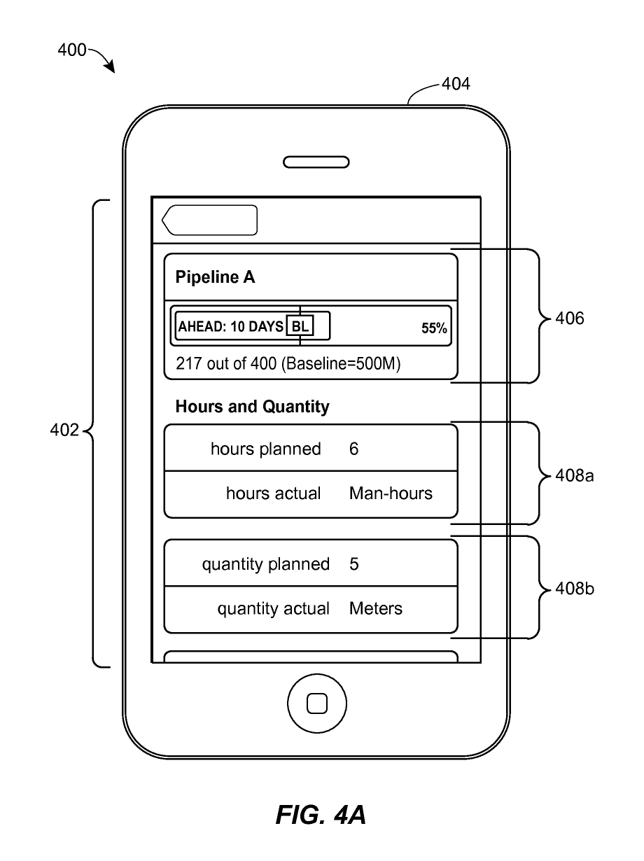

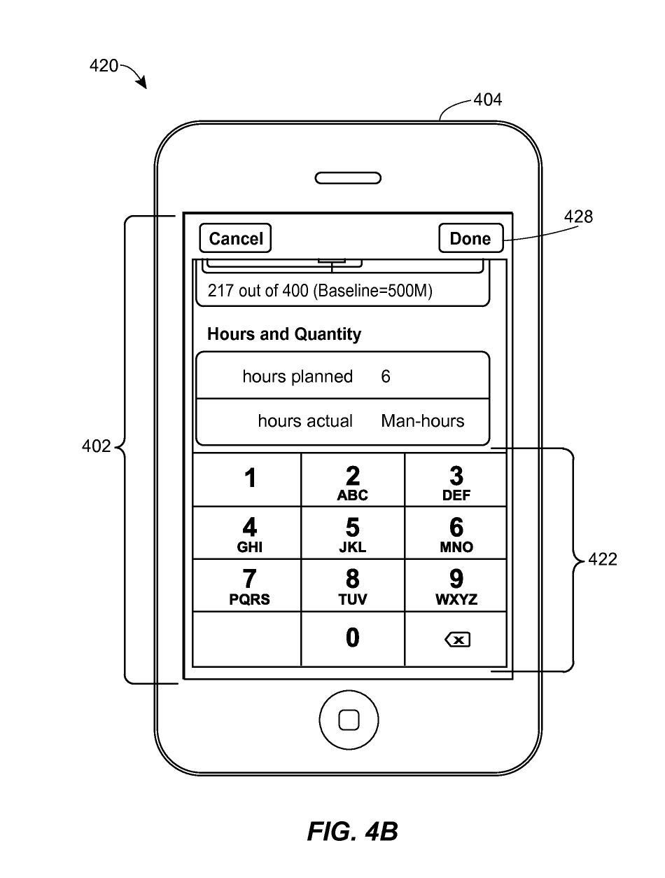

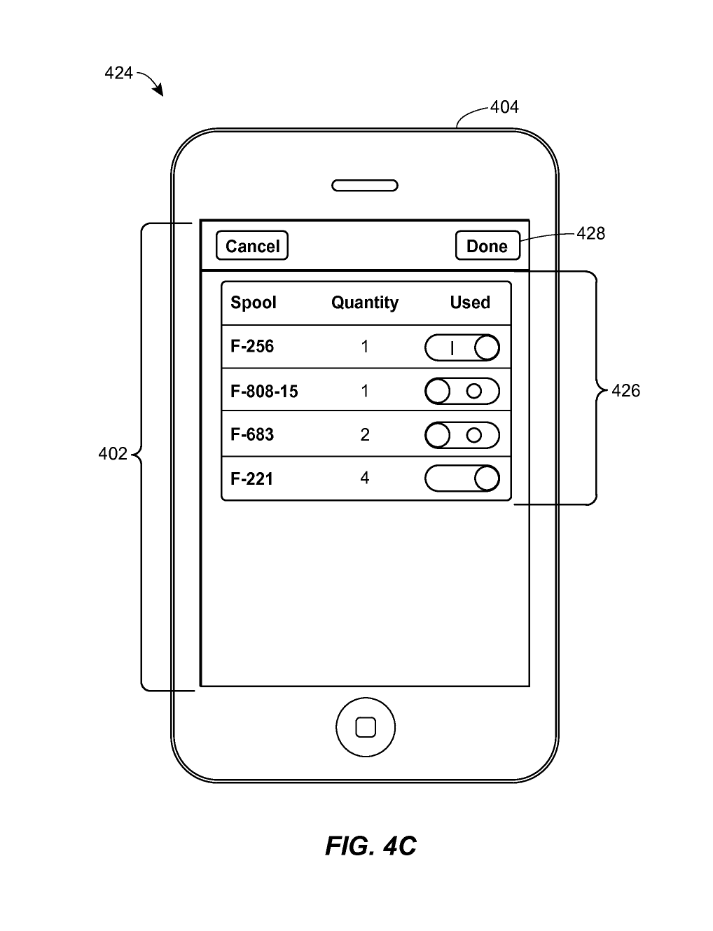

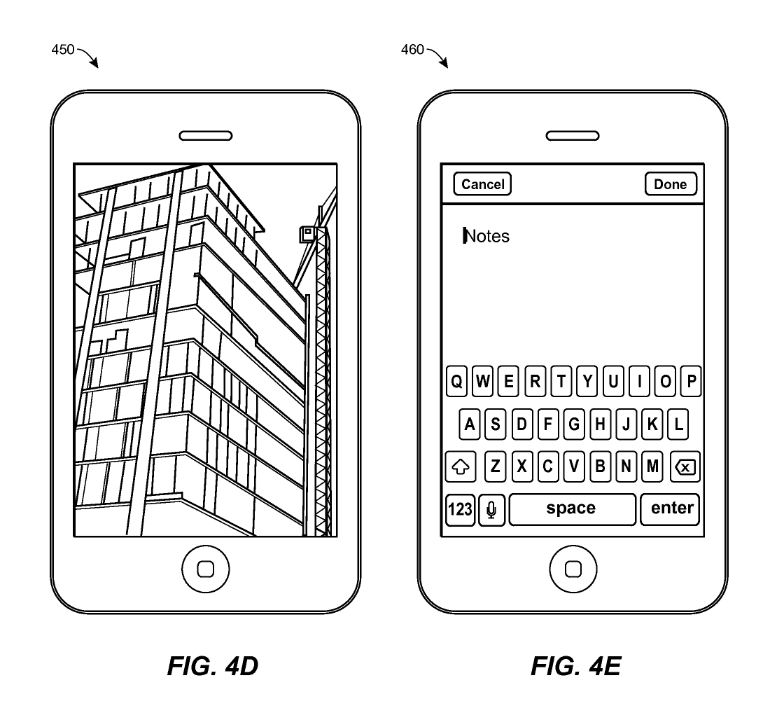

FIG. 2 is a flow diagram of an example method 200 for automatically updating work schedules for a certain work crew. The method 200 may be implemented by the productivity update engine 140, for example. To further illustrate the method, FIGS. 3A, 3B, and 4A-4E include example screenshots which may be displayed on user interfaces of work crew devices and/or management devices. However, it is understood that productivity updates and other information may be received or retrieved from work crews and/or management personnel in any suitable manner, including via any suitable digital interfaces, web pages, application interfaces, etc.

To begin, a set of initial work schedules are distributed to a work crew (block 202), where the work crew is assigned to one or more specific tasks on a project. Specifically, an engine, such as the productivity update engine 140, may distribute the work schedules to one or more of the work crew devices 110, and the work crew devices 110 may display or present the work schedules to member of the work crew via one or more user interfaces or displays. The work schedules may instruct the work crew on how much work, what types of work, etc. are expected of the work crew during a certain time period (one or more shifts, days, weeks, months, etc.).

In some implementations, each of the initial set of work schedules is different from other of the initial set of work schedules. For example, a work crew may include multiple different members, each with unique responsibilities or assigned task (e.g., supervising the crew, operating a front loader, mixing concrete, etc.). As such, each member of the work crew may receive a “personalized” work schedule indicating specific activities or work tasks expected of that respective member of the work crew during the certain time period.

The scheduler engine 142 may generate the initial set of work schedules based on an initial productivity model, in an implementation. For example, the scheduler engine 142 may generate initial productivity estimates based on initial assumptions of work crew productivity, such as average productivities for similar (same size, same composition, etc.) work crews, or the scheduler engine 142 may retrieve such initial productivity estimates from the database 170. The scheduler engine 142 may also utilize secondary sources of information, such as weather forecasts, traffic predictions, etc., to accurately predict work crew productivity.

Subsequently, the scheduler engine 142 may generate (e.g., by executing the schedule generator module 160) an initial set of work schedules for the work crew based on the initial productivity estimates and communicate these work schedules to the productivity update engine 140. The productivity update engine 140 may then distribute (e.g., by executing the crew interaction module 154) the initial set of work schedules to members of the work crew operating the work crew devices 110. Generally, any one or combination of the back-end components 106 may operate to distribute the initial set of work schedules to the work crew devices 110.

FIG. 3A is an example screen shot 300 of a work schedule 302 displayed on a user interface of a work crew device 304, such as one of the work crew devices 110. The work schedule 300 may have been generated by the scheduler engine 142, distributed by the productivity update engine 144, and subsequently displayed by the work crew device 304 (e.g., on a touchscreen), in an implementation.

The work schedule 302 may include one or more work tasks 306a, 306b, and 306c assigned to a member of the work crew (e.g., operating the work crew device 304) for a current day of work (i.e., “today”). By way of example, each of the work tasks 306a, 306b, and 306c may indicate: (i) a label of the respective work task 306a, 306b, or 306c; (ii) a number of man-hours (labeled “m-h”) to be worked by the member of the work crew on the respective work task 306a, 306b, or 306c; (iii) a quantity of units to be produced, built, or generated by the member of the work crew on the respective work task 306a, 306b, or 306c (e.g., a number of sections of a pipeline to be installed); and (iv) a current status (308a, 308b, or 308c, respectively) indicating a current overall status of the work task, such as on schedule, ahead of schedule, or behind schedule by a certain percentage. Generally, it is understood that work schedules may be organized in any suitable manner for any particular member of a work crew and may utilize any type and number of digital icons, images, labels, etc.

In some implementations, the work schedule 302 may be interactive such that the member of the work crew, operating the work crew device 304, may “navigate” through portions of the work schedule. For example, the member of the work crew operating the work crew device 304 may select (e.g., by a tap on a touchscreen) one of the work tasks 306a, 306b, and 306c to display further details of the selected one of the work tasks 306a, 306b, and 306c on the work crew device 304. The further information may include materials or tools needed to complete the selected work task, blueprints or drawings related to the work task, a listing of other work crew members assigned to the work task, a supervisor of the work task, etc.

The work schedule 302 may further allow a member of the work crew to navigate to work schedules for other time periods, such as other days, weeks, etc. in the future or past. For example, a member of the work crew operating the work crew device 304 may select (e.g., via a click or tap) one or more arrows 310 or one or more buttons 312 to navigate from a display of the work schedule for the current day, or today, to a work schedule for yesterday, the day before, etc. or to a work schedule for tomorrow, the next day, the day after next, etc.

FIG. 3B illustrates an example screenshot 350 of another work schedule 352 displayed on a different work crew device (not shown). In particular the work schedule 352 may be generated (e.g., by one of the engines 140, 142, or 144) to be displayed on a mobile computing device different from that of the work crew device 304. For example, the scheduler engine 142 may generate the work schedule 302 to be displayed on a smartphone device, whereas the scheduler engine 142 may generate the work schedule 352 to be displayed on a tablet computer device or laptop computer device. In this manner, the scheduler engine 142, or other suitable computing device, may generate various types of work schedules specially configured for efficient or visually pleasing display on corresponding types of work crew devices, in an implementation.

The work schedule 352 may also be distributed to a different member of a work crew as compared to the work schedule 302. For example, the productivity update engine 140 may distribute the work schedule 352 to a supervisor of a work crew and the work schedule 302 to a supervised member of the work crew. In an implementation, the supervisor's work schedule 352 may include more information, more detailed work tasks, further navigation or interaction features, etc. allowing the supervisor to efficiently and effectively supervise the work crew in a given day, or other time period.

Specifically, the work schedule 352 may include one or more indications of work tasks 354a and 354b. A member of the work crew operating a work crew device (displaying the work schedule 352) may select each of the work tasks 354a and 354b to expand the work tasks 354a and 354b. For example, a member of the work crew may select the work task 354a so as to display one or more work sub-tasks 356. In an implementation, the work sub-task 356 may include a listing of activities that must be completed in order to complete the work task 354a. In this way, a supervisor may quickly and easily view work tasks at both a high level and a low level (e.g., individual activities contributing the completion of work tasks). The work schedule 352 may further include timing information 358, such as current and baseline start and finish date/times and amounts of float available in certain tasks or activities.

The work schedule 352 may include additional navigation and/or interaction features, as compared with the work schedule 302, in an implementation. For example, the work schedule 352 may include search functionality, in the form of the search bar 360 (e.g., including one or more text boxes, drop down menus, and buttons), allowing a supervisor or other work crew member to search for particular types of task or activities. The work schedule 352 may also include one or more icons 362 allowing a supervisor, or other work crew member viewing the work schedule 352, to sort the work tasks 354a and 354b by activity type, start time, finish time, float, etc.

Returning to FIG. 2, productivity updates may be received from one or more work crew members in response to the distribution of the initial work schedules (block 204). In an example scenario, a work crew member may receive an initial work schedule (e.g, displayed on a corresponding work crew device in the form of the work schedule 302). The work crew member may subsequently work on tasks included in the work schedule (e.g., fitting pipes, pouring concrete, laying rebar, etc.) and enter into a corresponding work crew device (e.g., on a touchscreen) an actual amount of work accomplishing during a time period specified by the initial work schedule. The actual amount of work accomplished during the time period may be communicated, by the work crew device, to the productivity update engine 140.

In general, productivity updates, may include any suitable information related to an actual amount of work accomplished during a time period (e.g., a current day) specified by a work schedule. By way of example, productivity updates may include a number of man-hours worked, a quantity of units installed or built, physical measurement of new infrastructure additions, etc.

FIG. 4A is a screenshot 400 of an example update interface 402 in which a work crew member may enter an actual amount of work accomplished during a scheduled time period, the actual amount of work to be communicated and subsequently received by the productivity update engine 140. The update interface 402 may be displayed on the work crew device 404, for example. In one implementation, the work crew device 404 may display the update interface 402 upon a selection (by a work crew member) of one of the work tasks 306a, 306b, or 306c illustrated in FIG. 3A.

The update interface 402 includes: (i) task information 406 related to a work task assigned to the crew member operating the work crew device 404 and (ii) one or more update boxes 408a and 408b in which the work crew member operating the work crew device 404 may enter (e.g., via a touchscreen or keypad) actual amounts of work accomplished in the scheduled time period (e.g., a current day). In some cases, a work crew member may input multiple indications of actual work accomplished for each work task assigned to the work crew member. For example, in the update interface 402, a work crew member may enter an actual number of man-hours worked (see update box 408a) and an actual quantity of units or materials installed/produced (e.g., meters of pipeline installed, see update box 408b).

For further clarity, FIGS. 4B and 4C are screenshots of further work crew member interaction with the update interface 402. As illustrated in a screenshot 420 of FIG. 4B, when a work crew member operating the work crew device 404 selects the update box 408a, a touchscreen keypad 422 may be displayed allowing a work crew member to enter an actual number of man-hours worked during a time period specified by the work schedule. Further, as illustrated in a screenshot 424 of FIG. 4C, a selection of the update box 408b may trigger the display of one or more selectable icons 426 allowing a work crew member to specify specific materials used or installed during the scheduled time period. After entering indications of actual work accomplished, the work crew member operating the work crew device 404 may select one or more buttons, such as the buttons 428, to confirm the actual amount of work and send productivity updates to an engine, such as the productivity update engine 140.

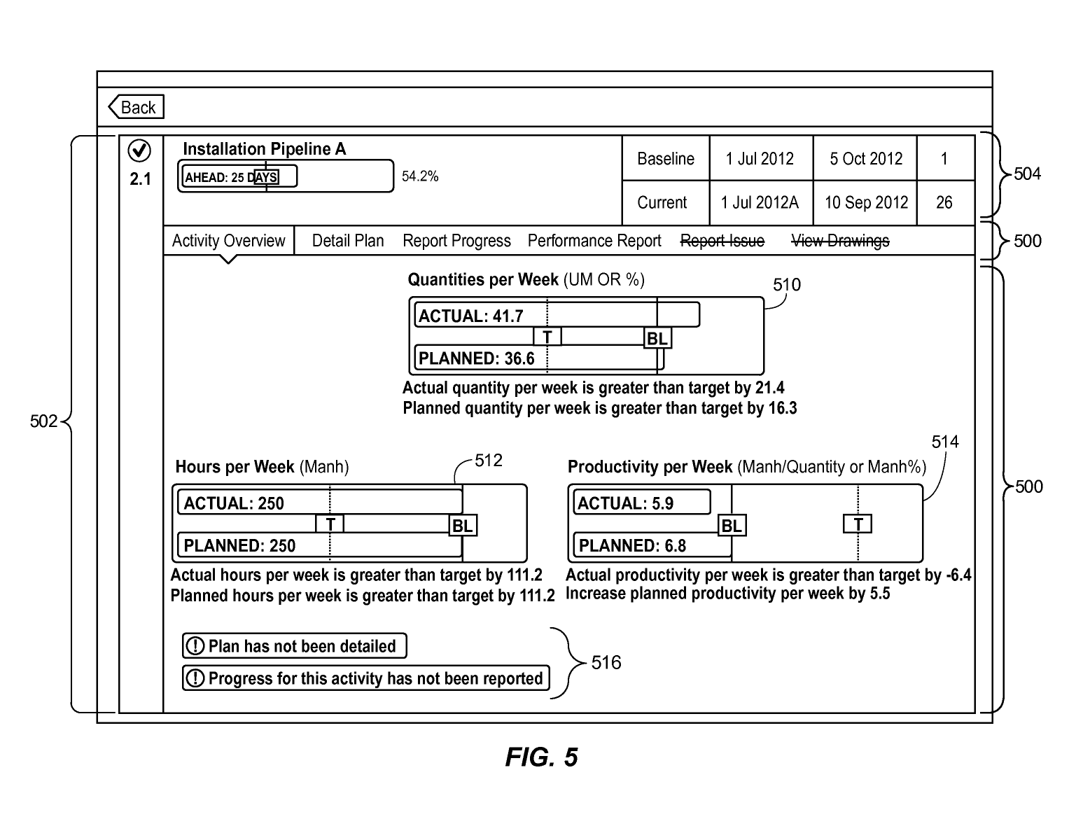

In some implementation, a member of a work crew may further document actual amounts of work accomplished (while working on a work schedule) by capturing and communicating images, videos, and/or text-based notes, as illustrated in FIGS. 4D and FIGS. 4E. In particular FIG. 4D is an example screenshot 450 of a camera interface of the client device 404 in which a member of a work crew may capture images or videos of a worksite. For example, the camera interface of the client device 404 may facilitate the capture photos and videos via one or more image capture components of the client device 404, such as digital cameras. FIG. 4E is an example screenshot 460 of a note-taking interface of the work crew device 404 in which a member of a work crew may author work task relate notes. The work crew device 404 may communicate such images, videos, and/or notes to a productivity update engine 140, and the productivity update engine 140 may subsequently store the information (e.g., in the database 170) for reporting and/or analysis, as further discussed with reference to FIG. 5-7.

Returning again to FIG. 2, productivity estimates may be updated or modified after receiving the productivity updates from one or more work crew members (block 206). For example, the productivity update engine 140 may modify or replace one or more productivity values in a productivity matrix, or the productivity update engine 140 may store newly generated productivity estimates in the database 170.

In some implementations, the productivity update engine 140 may update productivities according to a pre-defined rule-based or mathematically expressed model. In one scenario, an initial estimate of the productivity of a certain work crew may include an indication that the work crew is capable of installing ten meters of pipeline in a day. However, a productivity update from the work crew may indicate that, in a current or recent day of work, the work crew installed fourteen meters of pipeline. As such, the productivity update engine 140 may, based on a rule-based or mathematically expressed scheme, update the productivity estimate of the work crew to indicate an increased amount of pipeline per day, in the scenario. For example, the productivity update engine 140 may calculate a suitable fraction of the difference between fourteen meters per day, as indicated in the productivity updates from the work crew, and the initial estimate of ten meters per day. The productivity update engine 140 may then add this fraction to the initial estimate of ten meters per day to generate a new estimate.

Alternatively, in the example scenario, the productivity update engine 140 may utilize a rule-based scheme to generate new or updated productivity estimates. For example, the rule-based scheme may instruct the productivity update engine 140 to increase/decrease productivity estimates by pre-defined amounts if productivity updates from work crews are above/below certain threshold values. The rule-based scheme may also instruct the productivity update engine 140 to only update productivity estimates under certain conditions (such as when a certain number of deviating actual amounts of work are received or when weather or other conditions permit optimum or average efficiency).

In still another implementation, the productivity update engine 140 may utilize a finite or infinite impulse response function to update productivity estimates. For example, the productivity update engine 140 may calculate a moving average of productivity updates based on previously calculated, reported, or updated productivity estimates along with a most recent productivity update. In another example, the productivity update engine 140 may utilize an update scheme defined by a difference equation expressing an output (e.g., updated productivity estimate) in terms of an input (e.g., productivity update from the work crew). A transfer function of such a scheme may be programmed (e.g., in the productivity update module 152) based on the design of a suitable finite or infinite impulse response function.

In yet another implementation, the productivity update engine 140 may utilize a Kalman filter to produce updated productivity estimates based on productivity updates from a work crew. For example, the productivity update module 152 may execute an algorithm that operates recursively on previous productivity estimates and productivity updates along with a current productivity update to generate an updated estimate of productivity. Once a new productivity update is received from a work crew, the productivity update module 152 may update productivity estimates using a weighted average, with more weight being given to productivity estimates with higher certainty.

Generally, a productivity update engine 140 may update estimates of productivity according to any suitable rules or mathematical frameworks and based on information received from a work crew after working on one or more work schedules. For example, the productivity update engine 140 may update productivities by simply replacing an old or previous productivity estimate with a new productivity update from a work crew.

A productivity update engine may then cause a schedule generator, such as the schedule generator module 160 of the scheduler engine 142, to generate new work schedules based on the updated productivity estimates (block 208). For example, after updating estimates of productivity, the productivity update engine 140 may store the updated estimates in the database 170 and trigger (e.g., via a message or other electronic communication) the scheduler engine 142 to generate new work schedules based on the stored productivity estimates.

In some cases, the scheduler engine 142 may generate a plurality of new work schedules based on the updated productivity estimates, where some of the new work schedules may replace old work schedules generated based on initial estimates of productivity. For example, the scheduler engine 142 in cooperation with the productivity update engine 140 may: (i) initially distribute a plurality of work schedules for a plurality of time periods (e.g., days) based on initial estimates of productivity; (ii) update productivity estimates after receiving productivity updates corresponding to an actual amount of work completed on one or more of the plurality of time periods; and (iii) generate updated work schedule, based on the updated productivity estimates, for the remaining of the plurality of time periods.

In some other implementations, a productivity update engine 140 may distribute work schedules to members of a work crew at some pre-determined, or otherwise determined, time before the work schedule begins. As such, each work schedule may be generated based on up-to-date productivity estimates stored in the database 170, without the need to replace work schedules that are inconsistent with current estimates of productivity.

After new work schedules are generated, the new work schedules may be communicated to the work crew (block 210). For example, the productivity update engine 140, or other suitable engine or server, may communicate the work schedules to one or more members of a work crew via a common communication protocol, such as the Hypertext Transfer Protocol (HTTP), or via a protocol specially configured for managing a work project.

In addition to updating productivity estimates and triggering the generation of work schedules based on those estimates, productivity update engines may also update project path information, in an implementation, such as the project path information 176. For example, the productivity update engine 140 may generate quantities such as an estimated project duration, activity or task duration, or project cost based on updates to a critical path model. The productivity update engine 140 may also modify dependencies or other parameters of a critical path model such that project related metrics (e.g., cost, man-hours, activity length, critical activities, etc.) may be up-to-date for reporting purposes, as further discussed with reference to FIGS. 5-7.

Following block 210, the flow of example method 200 may return to block 204. In this manner, estimates of productivity and work schedules may be automatically updated as a project progresses based on productivity updates from members of one or more work crews. Work schedules may be dynamic and respond to actual conditions at a worksite such that the work schedules represent feasible deadlines and account for unexpected project issues.

In some implementations, the example method 200 may continue until a project or one or more work tasks complete. Specifically blocks 204-210 may iterate periodically, or otherwise, based on time periods specified in work schedules. For example, the productivity update engine 140 may receive productivity updates and update estimates of productivity daily, weekly, monthly, etc.

### Reporting

Because the techniques of the present disclosure allow productivity estimates and work schedules to be automatically updated, an engine, such as the reporting engine 144, may generate up-to-date reports about a project and communicate those reports to members of a work crew (e.g., supervisors) and/or management personnel (e.g., business managers, company executives, etc.). Reports may include, by way of example, metrics or Key Performance Indicators (KPIs) allowing a current state of a project to be assessed, such as current project costs, projected project costs, projected project duration, duration of certain work tasks or activities, percentages of completion, etc.

In some implementations, the reporting engine 144, productivity update engine 140, or other computing device may utilize a project path model (e.g., a critical path model) to generate KPIs for a project report. Further, the reporting engine 144 may utilize various templates or other structures to generate visually appealing and/or instructive displays for project reports. For example, the reporting engine may utilize up-to-date project data (e.g., updated productivity estimates, critical path model outcomes, captured worksite photos or videos, work crew member notes, etc.) to fill templates with instructive plots, graphs, tables, narratives, photos, etc.

FIG. 5 includes a screenshot 500 of an example report 502 communicated to members of a work crew or management personnel. For example, the reporting engine 144 may communicate the report 502 to one or more of the management devices 108. In some implementations, the reporting engine 144 may maintain a classification of work crew members (supervisors, foreman, etc.) and management personnel in the database 170 and may utilize the classification to send reports to certain parties (e.g., only supervisors or only business managers).

The report 502 includes, by way of example: (i) one or more work task labels 504 indicative of particular work tasks to be completed on a project; (ii) one or more navigation icons 506 allowing a member of a work crew of manager to navigate to other sections of the report, work schedules related to the report, etc.; and (iii) one or more visual indications 508 of current work crew performance. The visual indications 508 of current work crew performance may indicate actual and planned quantities per week 510, hours per week 512, and productivity per week 514.

In particular, the reporting engine 144 may generate the report 502 with the visual indications 508 based on up-to-date productivity estimates and or project path information in the database 170. The reporting engine 144 may retrieve data from the database 170 and prepare the report 502 with one or more bar charts, graphs, plots, text descriptions, alerts, etc. based on the retrieved data.

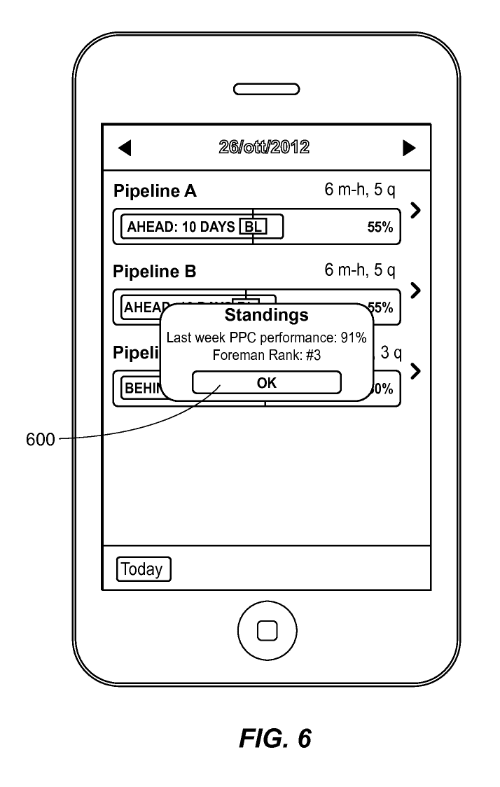

In some implementations, the reporting engine 144 may generate one or more alerts 516. The alerts 516 may indicate missing information, lack of communicated productivity updates, etc. such that a supervisor or manager may mitigate errors in the work schedule system or coach members of a work crew to improve efficiency and/or productivity updating. In addition to the visual alerts 516, a reporting engine 144 may alert supervisors or managers of a work crew of potential project issues or metrics, such as issues related to productivity, project costs, regulatory concerns, etc., via any suitable type of alert, such as an email, mobile alert, text message, etc. For example, the mobile alert 600 illustrated in FIG. 6 may alert a foreman of his ranked performance among a selected group of foreman in a certain time period.

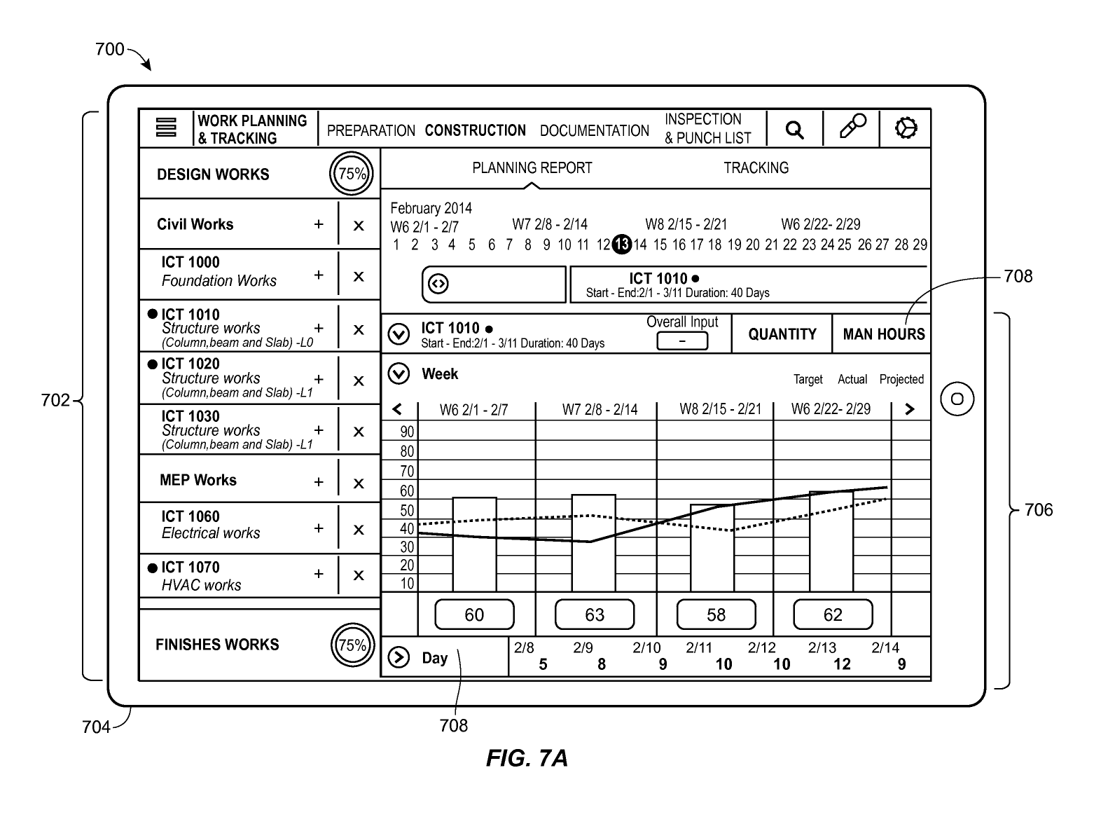

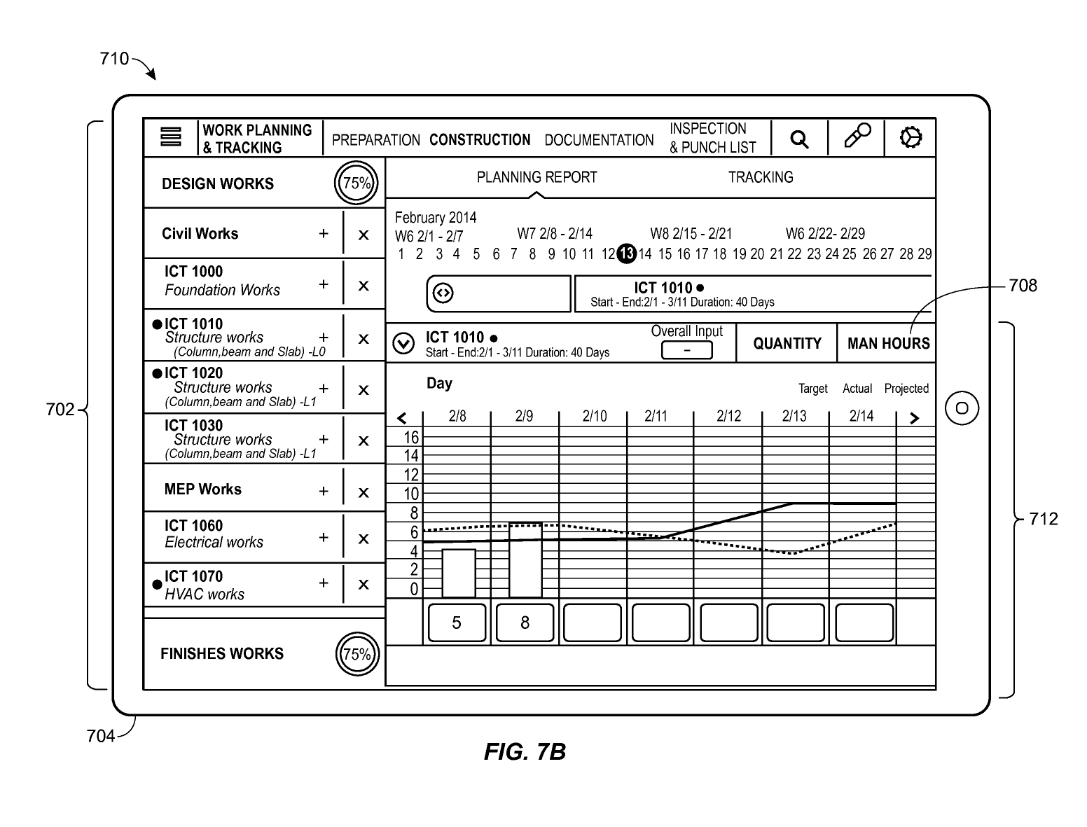

FIGS. 7A and 7B include screenshots 700 and 710 of another example report 702 displayed on a tablet computer device 704. The reporting engine 144 may utilize both up-to-date (i.e., current) data values, such as current productivity estimates, and historical (i.e., past) data values to generate one or more plots 706 and 712. The one or more plots 706 and 712 may indicate performance of a work crew member or work crew over time (e.g., per day or week), in an implementation. For example, the plots 706 may indicate a quantity of units produced per week and the plots 712 a quantity of units produced per day. In some cases, an operator of the tablet computer device 704 may interactivity switch between views of a plurality of plots, such as switching from a view of the plots 706 to a view of the plots 712, via one or more plot navigation buttons 708.

We claim:

1. A computer-implemented method for automatically updating work schedules, the computer-implemented method comprising:
distributing, via a computer network, a first plurality of work schedules to a work crew,
the first plurality of work schedules based on one or more initial estimates of productivity corresponding to the work crew, and
the first plurality of work schedules indicating a first estimated amount of work to be accomplished by the work crew on a project in a first time period;
receiving, via the computer network, productivity updates from the work crew, the productivity updates indicative of an actual amount of work accomplished by the work crew in the first time period;
based on one or more differences between the actual amount of work and the estimated amount of work, updating, with one or more processors, the one or more initial estimates of productivity to generate one or more updated estimates of productivity corresponding to the work crew;
causing, with the one or more processors, a schedule generator to generate a second plurality of work schedules based on the one or more updated estimates of productivity,
the second plurality of work schedules indicating a second estimated amount of work to be accomplished by the work crew on the project in a second time period different from the first time period, and
the second estimated amount of work differing from the first estimated amount of work; and
distributing, via the computer network, the second plurality of work schedules to the work crew.

2. The computer-implemented method of claim 1, further comprising determining, with the one or more processors, an updated critical path of the project based on the one or more updated estimates of productivity.

3. The computer-implemented method of claim 2, wherein the updated critical path of the project includes an updated timeline for completing the project.

4. The computer-implemented method of claim 2, wherein the updated critical path of the project includes updated dependencies between a plurality of project activities.

5. The computer-implemented method of claim 1, further comprising:
distributing, via the computer network, each of the first plurality of work schedules to a respective crew member device corresponding to a respective member of the work crew; and
distributing, via the computer network, each of the second plurality of work schedules to a respective crew member device corresponding to a respective member of the work crew.

6. The computer-implemented method of claim 1, further comprising:
distributing, via the computer network, the first plurality of work schedules to the work crew; and
distributing, via the computer network, the second plurality of work schedules to the work crew,
wherein the first plurality of work schedules and the second plurality of work schedules include at least one of an estimated quantity of units to be produced by the work crew, an estimated number of hours to be worked by the work crew, or one or more physical measurements of new additions to structures to be completed by the work crew.

7. The computer-implemented method of claim 1, further comprising receiving, via the computer network, the productivity updates from the work crew, the productivity updates including a plurality of productivity updates, each of the plurality of productivity updates corresponding to a respective one of the first plurality of work schedules.

8. The computer-implemented method of claim 1, further comprising
updating, with the one or more processors, the one or more initial estimates of productivity to generate the one or more updated estimates of productivity corresponding to the work crew,
wherein updating the one or more initial estimates of productivity is based on the one or more differences between the actual amount of work and the estimated amount of work and at least partially based on secondary information received via the computer network.

9. The computer-implemented method of claim 8, wherein the secondary information includes at least one of time sheets, target productivity rates, weather data, or regulatory information.

10. The computer-implemented method of claim 1, wherein at least one of the one or more initial estimates of productivity or the one or more updated estimates of productivity include an estimated number of units produced per man-hour.

11. The computer-implemented method of claim 1, wherein at least one of the one or more initial estimates of productivity or the one or more updated estimates of productivity include an estimated, measured addition to a structure per man-hour.

12. The computer-implemented method of claim 1, further comprising updating, with the one or more processors, the one or more initial estimates of productivity to generate the one or more updated estimates of productivity by replacing one or more elements of a productivity matrix with updated values.

13. The computer-implemented method of claim 12, further comprising causing, with the one or more processors, the schedule generator to generate the second plurality of work schedules based on a mathematical application of the productivity matrix.

14. The computer-implemented method of claim 13, further comprising causing, with the one or more processors, the schedule generator to generate the second plurality of work schedules based on a mathematical application of the productivity matrix in a optimization of an objective function.

15. The computer-implemented method of claim 1, further comprising updating, with the one or more processors, the one or more initial estimates of productivity to generate the one or more updated estimates of productivity based on at least one of a finite impulse response function, an infinite impulse response function, or a Kalman filter and based on the one or more differences between the actual amount of work and the estimated amount of work.

16. A computer device for automatically updating work schedules, the computer device comprising:
one or more processors; and
one or more non-transitory memories coupled to the one or more processors,
wherein the one or more memories include computer executable instructions stored therein that, when executed by the one or more processors, cause the one or more processors to:
distribute, via a computer network, a first plurality of work schedules to a work crew,
the first plurality of work schedules based on one or more initial estimates of productivity corresponding to the work crew, and
the first plurality of work schedules indicating a first estimated amount of work to be accomplished by the work crew on a project in a first time period,
receive, via the computer network, productivity updates from the work crew, the productivity updates indicative of an actual amount of work accomplished by the work crew in the first time period,
based on one or more differences between the actual amount of work and the estimated amount of work, update the one or more initial estimates of productivity to generate one or more updated estimates of productivity corresponding to the work crew,
cause a schedule generator to generate a second plurality of work schedules based on the one or more updated estimates of productivity,
the second plurality of work schedules indicating a second estimated amount of work to be accomplished by the work crew on the project in a second time period different from the first time period, and
the second estimated amount of work differing from the first estimated amount of work, and
distribute, via the computer network, the second plurality of work schedules to the work crew.

17. The computer device of claim 16, wherein updating the one or more initial estimates of productivity to generate the one or more updated estimates of productivity includes replacing one or more elements of a productivity matrix with updated values.

18. The computer device of claim 17, wherein causing the schedule generator to generate the second plurality of work schedules is based on a mathematical application of the productivity matrix in an optimization of an objective function.

19. A system for managing a project based on automatically updated productivities, the system comprising:
a scheduler engine configured to generate work schedules based on productivity estimates corresponding to a work crew; and
a productivity update engine coupled to the scheduler engine and configured to:
distribute, via a computer network, a first plurality of work schedules to a work crew,
the first plurality of work schedules generated by the scheduler engine based on one or more initial estimates of productivity corresponding to the work crew, and
the first plurality of work schedules indicating a first estimated amount of work to be accomplished by the work crew on a project in a first time period,
receive, via the computer network, productivity updates from the work crew, the productivity updates indicative of an actual amount of work accomplished by the work crew in the first time period,
based on one or more differences between the actual amount of work and the estimated amount of work, update, with the one or more processors, the one or more initial estimates of productivity to generate one or more updated estimates of productivity corresponding to the work crew,
cause, with the one or more processors, the scheduler engine to generate a second plurality of work schedules based on the one or more updated estimates of productivity,
the second plurality of work schedules indicating a second estimated amount of work to be accomplished by the work crew on the project in a second time period different, and
the second estimated amount of work differing from the first estimated amount of work, and
distribute, via the computer network, the second plurality of work schedules to the work crew.

20. The system of claim 19, wherein the productivity update engine is further configured to determine, with the one or more processors, an updated critical path of the project based on the one or more updated estimates of productivity.
